(19) United States
(12) Patent Application Publication
(10) Pub. No.: US 2025/0388048 A1
(43) Pub. Date: Dec. 25, 2025

(54) WHEEL FOR VEHICLE

(71) Applicants: TOYOTA JIDOSHA KABUSHIKI KAISHA, Toyota-shi (JP); TOGO SEISAKUSYO CORPORATION, Aichi-gun (JP); TOYOTSU AUTOMOTIVE CREATION CORPORATION, Nagoya-shi (JP); Excell Corporation, Matsudo City (JP)

(72) Inventors: Tomoyuki ISHIKAWA, Nisshin-shi (JP); Teppei Ito, Toyota-shi (JP); Kei Takakuwa, Chiryu-shi (JP); Akira Kinoshita, Toyota-shi (JP); Kenji Okabe, Aichi-gun (JP); Yuho Furumori, Nisshin-shi (JP); Yoshinori Oosawa, Kiryu-shi (JP)

(73) Assignees: TOYOTA JIDOSHA KABUSHIKI KAISHA, Toyota-shi (JP); TOGO SEISAKUSYO CORPORATION, Aichi-gun (JP); TOYOTSU AUTOMOTIVE CREATION CORPORATION, Nagoya-shi (JP); Excell Corporation, Matsudo City (JP)

(21) Appl. No.: 19/241,993

(22) Filed: Jun. 18, 2025

(30) Foreign Application Priority Data
Jun. 20, 2024 (JP) 2024-099881

(51) Int. Cl. B60B 21/12; F16B 2/20; G10K 11/172

(52) U.S. Cl. CPC B60B 21/12; F16B 2/20; G10K 11/172; B60B 2900/133

(57) ABSTRACT

A wheel for a vehicle includes: two vertical walls provided on an outer peripheral face of the wheel at two positions spaced apart in a rotation axis direction, each of the vertical walls projecting outward in a radial direction and being continuous in a circumferential direction; and a plurality of resonators made of a synthetic resin, the resonators being attached to the wheel between the vertical walls at a plurality of positions evenly spaced in the circumferential direction. Each of the resonators has a rectangular outer shape, and has two opposite sides locked to the vertical walls. A clip for preventing the resonator from coming off is locked to the vertical walls to cover an outer diameter side of the resonator.

### CROSS-REFERENCE TO RELATED APPLICATION

This application claims priority to Japanese Patent Application No. 2024-099881 filed on Jun. 20, 2024, incorporated herein by reference in its entirety.

### BACKGROUND

### 1. Technical Field

The disclosure relates to a wheel for a vehicle.

### 2. Description of Related Art

Japanese Patent No. 4551422 (JP 4551422 B) (Japanese Unexamined Patent Application Publication No. 2008-279873 (JP 2008-279873 A)) discloses “a Helmholtz resonator that reduces noise caused by air column resonance inside an air chamber of a tire is fixed by being hooked onto a rim of a wheel”.

### SUMMARY

In JP 4551422 B (JP 2008-279873 A), the temperature of the rim of the wheel becomes a high temperature close to 80° C. due to heat radiated from a brake, depending on a use environment. Thus, the resonator formed of a resin component may undergo creep deformation that crushes a tubular portion due to aged deterioration. When such creep deformation occurs, the noise reduction effect may be reduced, and the resonator may become likely to come off the wheel.

In view of such circumstances, it is an object of the present disclosure to provide a wheel for a vehicle that can prevent a resonator from coming off.

The present disclosure provides a wheel for a vehicle. The wheel includes two vertical walls, and a plurality of resonators. The two vertical walls are provided on an outer peripheral face of the wheel at two positions spaced apart in a rotation axis direction, and each of the vertical walls projects outward in a radial direction and is continuous in a circumferential direction. The resonators are made of a synthetic resin and attached to the wheel between the two vertical walls at a plurality of positions evenly spaced in the circumferential direction. Each of the resonators has a rectangular outer shape, and has two opposite sides locked to the two vertical walls. A clip for preventing the resonator from coming off is locked to the two vertical walls to cover an outer diameter side of the resonator.

With this configuration, even if the resonator becomes likely to come off the wheel due to aged deterioration, the clip can prevent the resonator from coming off the wheel.

In the wheel, the clip may have a body made of a rectangular plate, and first and second legs bent at right angles from two opposite sides of the body. A range in the body that covers the outer diameter side of the resonator is a predetermined length range at a partway position of two sides of the resonator perpendicular to the two sides in a longitudinal direction. The first and second legs may be locked to the two vertical walls.

With this configuration, since the clip has a simple configuration, it is possible to reduce the weight and manufacturing cost of the clip.

In the wheel, the width of an area in each of the first and second legs from the body to a position before a tip may be set to be smaller than the width of an area from the position before the tip to the tip.

In the wheel, each of the two vertical walls may have a plurality of cutouts provided at a plurality of positions evenly spaced in the circumferential direction. Each of the resonators may have a plurality of cutouts provided at a plurality of positions along the two opposite sides, and a plurality of projecting pieces present between the cutouts may be locked to grooves provided on faces of the two vertical walls facing each other. The distance between the cutouts of the resonator may be set to be larger than the distance between the cutouts of each of the two vertical walls. The smaller-width area of each of the first and second legs of the clip may be fitted in the cutout of the vertical wall of the wheel. The area of each of the first and second legs from the position before the tip to the tip may be fitted in the cutout of the resonator.

The present disclosure can provide a wheel for a vehicle that can prevent a resonator from coming off.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a perspective view of a wheel for a vehicle according to an embodiment of the present disclosure in a state before a resonator is attached to the wheel;

FIG. 2 is a perspective view of the wheel with the resonator attached;

FIG. 3 is a side view of the wheel of FIG. 2;

FIG. 4 is a front view of the resonator;

FIG. 5 is a rear view of the resonator;

FIG. 6 is a diagram taken along line (6)-(6) of FIG. 3, viewed from the direction of arrow;

FIG. 7A is a side view of a clip;

FIG. 7B is a left side view of the clip shown in FIG. 7A;

FIG. 7C is a right side view of the clip shown in FIG. 7A;

FIG. 8 is an enlarged view of an area within a long dashed short dashed line of FIG. 2; and

FIG. 9 is a diagram viewed from the direction of arrow (9) of FIG. 8.

### DETAILED DESCRIPTION OF EMBODIMENTS

Hereinbelow, a best mode for carrying out the disclosure will be described in detail with reference to the accompanying drawings.

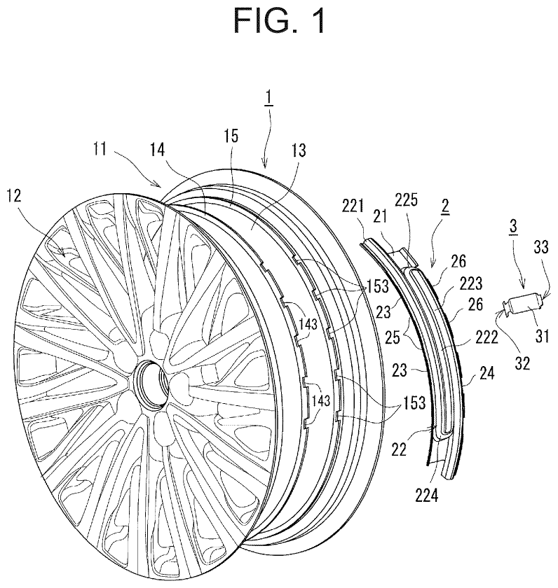

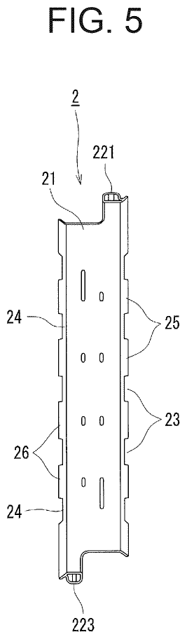

FIGS. 1 to 9 show an embodiment of the present disclosure. These drawings disclose a resonator 2 to be attached to a wheel 1 for a vehicle, and a clip 3 for preventing the resonator 2 from coming off.

The wheel 1 includes a rim 11 to which a tire (not shown) is fitted, and a disk 12 to be coupled to a hub (not shown) of the vehicle. The wheel 1 is formed of, for example, metal such as an aluminum alloy or a magnesium alloy.

Vertical walls 14, 15 are provided on an outer peripheral face of a well portion 13 of the rim 11 at two positions that are separated by a predetermined distance in a width direction. Each of the vertical walls 14, 15 projects outward in the radial direction and is continuous in the circumferential direction.

Both the vertical wall 14 and the vertical wall 15 have a shape like a rail. The vertical wall 14 located on the outer face side of the wheel 1 is referred to as the “outer vertical wall 14”, and the vertical wall 15 located on the inner face side of the wheel 1 is referred to as the “inner vertical wall 15”.

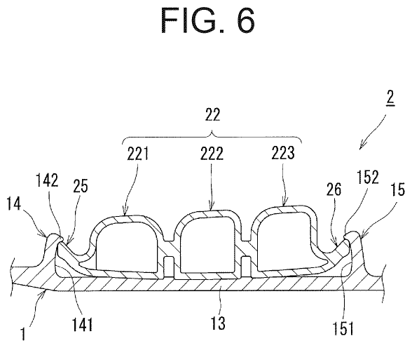

As shown in FIG. 6, in the wheel 1, an inner face of the outer vertical wall 14 has a groove 141, and an inner face of the inner vertical wall 15 has a groove 151.

Since the grooves 141, 151 are provided, an upper end of the inner face of the outer vertical wall 14 has an overhang 142, and an upper end of the inner face of the inner vertical wall 15 has an overhang 152. The overhang 142 projects toward the overhang 152, and the overhang 152 projects toward the overhang 142.

In the present embodiment, the outer vertical wall 14 is provided with a plurality of cutouts 143 in a plurality of predetermined angle regions where the resonators 2 are to be attached. The cutouts 143 are evenly spaced apart in the circumferential direction. The inner vertical wall 15 is provided with a plurality of cutouts 153 in a plurality of predetermined angle regions where the resonators 2 are to be attached. The cutouts 153 are evenly spaced apart in the circumferential direction.

The resonators 2 are used to reduce air column resonance sound inside an air chamber formed between the wheel 1 and the tire (not shown) and attached to the outer peripheral face of the well portion 13 of the rim 11 of the wheel 1 at a plurality of positions evenly spaced in the circumferential direction.

The resonators 2 are attached at the positions evenly spaced in the circumferential direction of the wheel 1, for example, at two opposite positions 180 degrees apart in the circumferential direction of the wheel 1, at three positions 120 degrees apart in the circumferential direction of the wheel 1, or at four positions 90 degrees apart in the circumferential direction of the wheel 1.

Each resonator 2 includes a substrate 21, and a tubular portion 22 provided on the substrate 21. Each resonator 2 is formed of a synthetic resin. For example, the synthetic resin is preferably a material (e.g., polypropylene) that has elasticity, heat resistance against heat generated by traveling of the vehicle, and chemical resistance against a puncture repair agent.

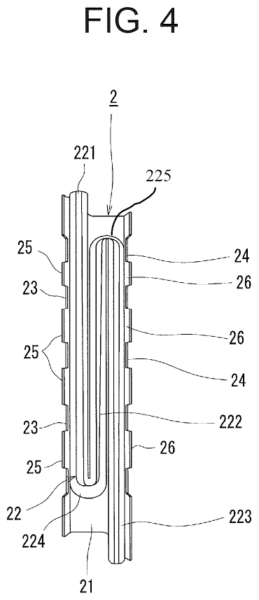

The substrate 21 has a shape that is rectangular in plan view and bent in a C-shape in side view. As shown in FIG. 4, the substrate 21 has cutouts 23 that are provided on its left long side (referred to as the first side) at a plurality of positions in the longitudinal direction such that the cutouts 23 are evenly spaced apart, and cutouts 24 that are provided on its right long side (referred to as the second side) at a plurality of positions in the longitudinal direction such that the cutouts 24 are evenly spaced apart.

Projecting pieces 25 each having a rectangular shape in plan view are present between the cutouts 23, and projecting pieces 26 each having a rectangular shape in plan view are present between the cutouts 24. As will be described further below, the projecting pieces 25, 26 are locked to the grooves 141, 151 of the wheel 1.

As shown in FIG. 6, each of the left projecting pieces 25 has a shape inclined obliquely upward in its projecting direction, and each of the right projecting pieces 26 has a shape inclined obliquely upward in its projecting direction.

The distance between the left cutouts 23 is set to be larger than the distance between the cutouts 143 on the outer vertical wall 14 of the wheel 1. The distance between the right cutouts 24 is set to be larger than the distance between the cutouts 153 of the inner vertical wall 15 of the wheel 1.

The tubular portion 22 has a zigzag shape. Specifically, the tubular portion 22 has a shape that makes a U-turn at two points that are spaced apart in its central axis direction.

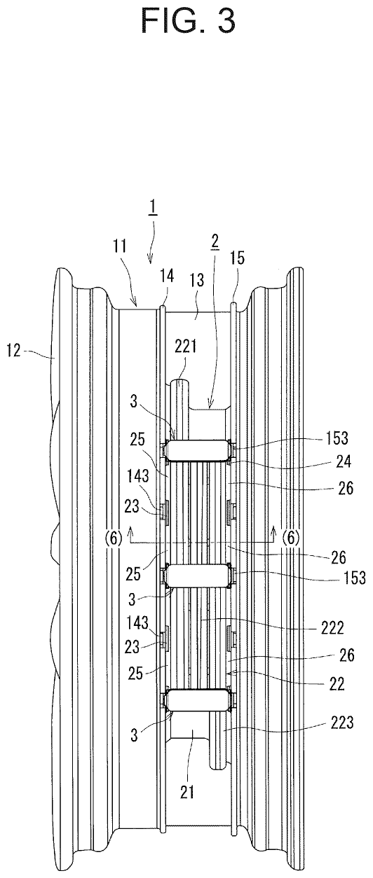

More specifically, the tubular portion 22 has a first straight portion 221 (the left end in FIGS. 3, 4), a second straight portion 222 (the center in FIGS. 3, 4), a third straight portion 223 (the right end in FIGS. 3, 4), a first U-shaped portion 224 (the lower side in FIGS. 3, 4), and a second U-shaped portion 225 (the upper side in FIGS. 3, 4).

The first to third straight portions 221 to 223 are disposed such that their central axes are parallel to the left first side and the right second side of the substrate 21 and disposed side by side parallel to each other in the short-side direction of the substrate 21.

A first end (upper end in FIGS. 3, 4) side of each of the first to third straight portions 221 to 223 in its central axis direction is disposed on the upper short side (referred to as the third side) of the substrate 21 located on a first end (upper end in FIGS. 3, 4) of the substrate 21 in its longitudinal direction. A second end (lower end in FIGS. 3, 4) side of each of the first to third straight portions 221 to 223 in its central axis direction is disposed on the lower short side (referred to as the fourth side) of the substrate 21 located on a second end (lower end in FIGS. 3, 4) of the substrate 21 in its longitudinal direction.

Both ends of the tubular portion 22 in its central axis direction are open. Specifically, the first end (upper end in FIGS. 3, 4) of the first straight portion 221 in its central axis direction has an opening on the third side of the substrate 21, and the second end (lower end in FIGS. 3, 4) of the third straight portion 223 in its central axis direction has an opening on the fourth side of the substrate 21.

When a rotation direction of the wheel 1 is, for example, the direction of arrow in FIG. 3, the opening on the first end side of the first straight portion 221 is on the upstream side in the rotation direction of the wheel 1, and the opening on the second end side of the third straight portion 223 is on the downstream side in the rotation direction of the wheel 1.

The second end side of the first straight portion 221 in its central axis direction and the second end side of the second straight portion 222 in its central axis direction are coupled through the first U-shaped portion 224. The first end side of the second straight portion 222 and the first end side of the third straight portion 223 are coupled through the second U-shaped portion 225.

The clip 3 prevents the resonator 2 attached to the wheel 1 from coming off. The resonator 2 is provided with a plurality of clips 3 at a plurality of positions (e.g., three positions) evenly spaced in the longitudinal direction of the resonator 2. In FIG. 1, only one clip 3 is shown.

The material of the clip 3 is a metal material (e.g., stainless steel) and has elasticity. However, the clip 3 may be formed of, for example, a synthetic resin having properties equivalent to those of the material of the resonator 2.

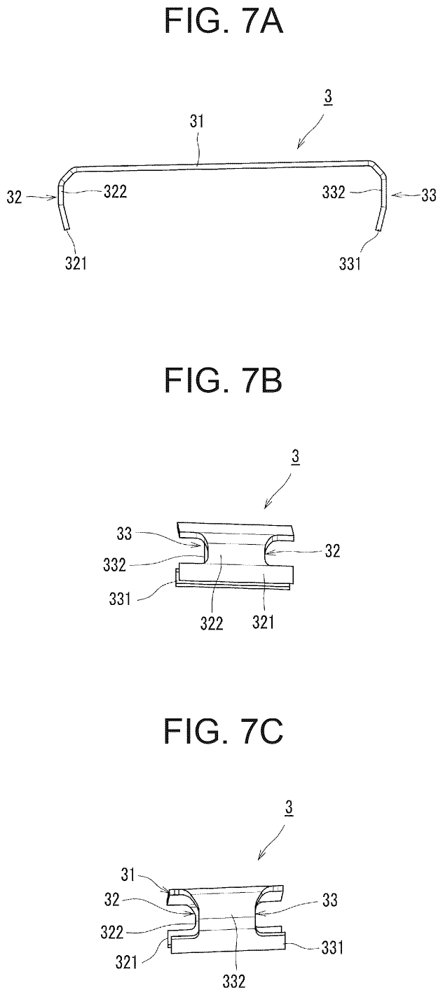

As shown in FIGS. 1, 7A, 7B, and 7C, the clip 3 has a body 31, and first and second legs 32, 33.

The body 31 is formed of a rectangular plate. The first and second legs 32, 33 are bent at right angles from two short sides of the body 31.

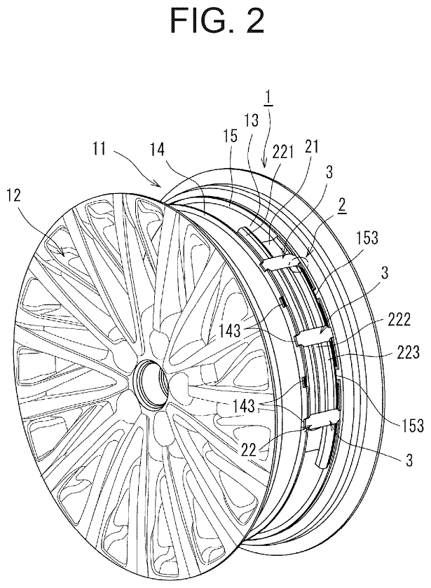

The width dimension of the body 31 in the short-side direction (the range that covers the outer diameter side of the resonator 2) is a predetermined length range at a partway position of the first and second sides of the resonator 2 in the longitudinal direction as shown in FIG. 2.

As shown in FIGS. 7B and 7C, the first and second legs 32, 33 have an upside-down T-shape in side view. Areas from the body 31 to positions before tips are referred to as constricted portions 322, 332, and areas from the positions before the tips to the tips are referred to as tip portions 321, 331.

The width of each of the tip portions 321, 331 is set to be equal to the width of the body 31 in the short-side direction. The width of each of the constricted portions 322, 332 is set to be smaller than the width of the body 31 in the short-side direction.

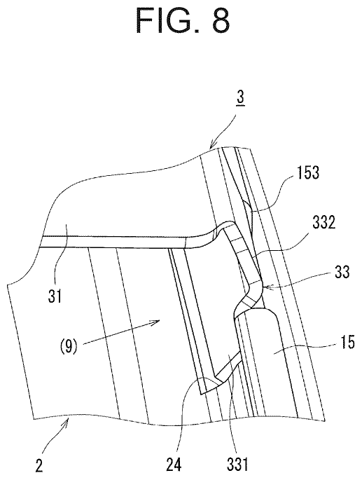

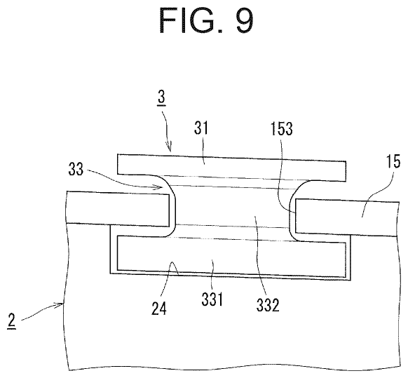

As shown in FIGS. 8 and 9, when the clip 3 is attached to the wheel 1 with the resonator 2 attached, the tip portions 321, 331 of the first and second legs 32, 33 are fitted into the left and right cutouts 23, 24 of the resonator 2 with appropriate clearances, the constricted portion 322 of the first leg 32 is fitted into the cutout 143 of the outer vertical wall 14 of the wheel 1 with an appropriate clearance, and the constricted portion 332 of the second leg 33 is fitted into the cutout 153 of the inner vertical wall 15 with an appropriate clearance. The dimensions of each of the clearances are set to dimensions required to enable the fitting.

Next, an example of the procedure and operation for attaching the resonator 2 to the wheel 1 will be described.

The resonator 2 is fitted between the outer vertical wall 14 and the inner vertical wall 15 of the wheel 1. When the left and right projecting pieces 25, 26 of the resonator 2 are inserted into the grooves 141, 151 of the outer vertical wall 14 and the inner vertical wall 15 while being elastically deformed one by one, the left and right projecting pieces 25, 26 are elastically restored, and the tips of the projecting pieces 25, 26 in the projecting direction are locked to inner corners of the grooves 141, 151 of the outer vertical wall 14 and the inner vertical wall 15 near the upper ends of the vertical walls 14, 15, that is, to the overhangs 142, 152.

As shown in FIG. 9, the left cutout 23 of the resonator 2 is aligned with the cutout 143 of the outer vertical wall 14 of the wheel 1, and the right cutout 24 of the resonator 2 is aligned with the cutout 153 of the inner vertical wall 15 of the wheel 1.

In this manner, when the resonator 2 is attached to the wheel 1, the left and right projecting pieces 25, 26 of the resonator 2 are locked into the grooves 141, 151 of the wheel 1 while being elastically deformed one by one. Thus, for example, compared to the case in which the cutouts 23, 24 are not provided on the left first side and right second side of the resonator 2, it becomes easier to elastically deform each of the left and right projecting pieces 25, 26 and lock the left and right projecting pieces 25, 26 in the grooves 141, 151. This makes it easier to attach the resonator 2 to the wheel 1.

Then, the clips 3 are attached to the wheel 1 with the resonator 2 attached to cover the resonator 2 from the outer diameter side at the positions evenly spaced in the longitudinal direction of the resonator 2.

Specifically, as shown in FIGS. 8 and 9, while the first and second legs 32, 33 of the clip 3 are elastically deformed such that the first and second legs 32, 33 are brought closer to each other, the tip portions 321, 331 are fitted into the left and right cutouts 23, 24 of the resonator 2 and then inserted into the grooves 141, 151 of the wheel 1, and the constricted portions 322, 332 of the first and second legs 32, 33 are fitted into the cutouts 143, 153 of the two vertical walls 14, 15 of the wheel 1.

In this state, the first and second legs 32, 33 of the clip 3 are pressed against the two vertical walls 14, 15 of the wheel 1 by the elastic restoring force of the clip 3. Thus, the clip 3 is attached in a positioned state to the wheel 1.

As shown in FIG. 9, clearances in the circumferential and radial directions of the wheel 1 are present between the tips portions 321, 331 of the first and second legs 32, 33 of the clip 3 and the left and right cutouts 23, 24 of the resonator 2. In addition, clearances in the circumferential direction of the wheel 1 are present between the constricted portions 322, 332 of the first and second legs 32, 33 of the clip 3 and the cutouts 143, 153 of the two vertical walls 14, 15 of the wheel 1. Thus, the clip 3 is allowed to be displaced outward in the radial direction and in the circumferential direction by the amount of the clearances.

However, the clip 3 is prevented from being displaced outward in the radial direction and in the circumferential direction by a greater amount than the clearances.

When the centrifugal force of the rotation of the wheel 1 acts on the resonator 2 and the clip 3, the tip portions 321, 331 of the first and second legs 32, 33 of the clip 3 are pressed against the overhangs 142, 152 of the wheel 1, which prevents the clip 3 from coming off outward in the radial direction. This prevents the resonator 2 from coming off.

In addition, when a force in one direction of the circumferential direction of the wheel 1 acts on the clip 3, the constricted portions 322, 332 of the first and second legs 32, 33 of the clip 3 are pressed against the cutouts 143, 153 of the two vertical walls 14, 15 of the wheel 1, which prevents the clip 3 from largely moving in the circumferential direction.

As described above, with the resonator 2 of the embodiment to which the present disclosure is applied, the resonator 2 can be easily attached to the wheel 1. In addition, even if the resonator 2 becomes likely to come off the wheel 1 due to aged deterioration, the clip 3 can prevent the resonator 2 from coming off. This makes it possible to maintain the effect of the resonator 2 reducing noise in the wheel 1 for a long period of time.

Typically, if the diameter of the wheel 1 is increased, the unsprung weight of the vehicle increases due to the increase in the weight of the wheel 1, which worsens the riding comfort. If the weight of the wheel 1 is reduced to improve the riding comfort, the rigidity of the wheel 1 is reduced, which worsens the NV performance. Thus, in order to improve the NV performance while ensuring a sufficient rigidity of the wheel 1 having an increased diameter, the resonator 2 may be attached to the wheel 1. In this case, the problem is how to make it easier to attach the resonator 2 to the wheel 1 and how to make the resonator 2 unlikely to come off the wheel 1 as the wheel 1 rotates. The above embodiment can solve the problem.

The present disclosure is not limited only to the above embodiment and can be modified as appropriate within the scope of the claims and the scope equivalent to the claims.

(1) In the above embodiment, the number of straight portions and the number of U-shaped portions of the tubular portion 22 of the resonator 2 can be set to any number.

(2) In the above embodiment, the distance between the left cutouts 23 of the resonator 2 and the distance between the right cutouts 24 of the resonator 2, and the distance between the cutouts 143 of the wheel 1 and the distance between the cutouts 153 of the wheel 1 can be set to any distance.

(3) In the above embodiment, the width dimension and the projecting dimension in the longitudinal direction of the left and right projecting pieces 25, 26 of the resonator 2 can be set to any dimension.

The present disclosure is suitably used as a wheel for a vehicle.

What is claimed is:

1. A wheel for a vehicle comprising:
two vertical walls provided on an outer peripheral face of the wheel at two positions spaced apart in a rotation axis direction, each of the vertical walls projecting outward in a radial direction and being continuous in a circumferential direction; and
a plurality of resonators made of a synthetic resin, the resonators being attached to the wheel between the two vertical walls at a plurality of positions evenly spaced in the circumferential direction, wherein:
each of the resonators has a rectangular outer shape, and has two opposite sides locked to the two vertical walls; and
a clip for preventing the resonator from coming off is locked to the two vertical walls to cover an outer diameter side of the resonator.

2. The wheel according to claim 1, wherein:
the clip has
a body made of a rectangular plate, and
first and second legs bent at right angles from two opposite sides of the body;
a range in the body that covers the outer diameter side of the resonator is a predetermined length range at a partway position of two sides of the resonator perpendicular to the two sides in a longitudinal direction; and
the first and second legs are locked to the two vertical walls.

3. The wheel according to claim 2, wherein a width of an area in each of the first and second legs from the body to a position before a tip is set to be smaller than a width of an area from the position before the tip to the tip.

4. The wheel according to claim 3, wherein:
each of the two vertical walls has a plurality of cutouts provided at a plurality of positions evenly spaced in the circumferential direction;
each of the resonators has a plurality of cutouts provided at a plurality of positions along the two opposite sides, and a plurality of projecting pieces present between the cutouts is locked to grooves provided on faces of the vertical walls facing each other,
a distance between the cutouts of the resonator is set to be larger than a distance between the cutouts of each of the two vertical walls;
the smaller-width area of each of the first and second legs of the clip is fitted in the cutout of the vertical wall of the wheel; and
the area of each of the first and second legs from the position before the tip to the tip is fitted in the cutout of the resonator.
